(19) United States
(12) Patent Application Publication
(10) Pub. No.: US 2024/0370808 A1
(43) Pub. Date: Nov. 7, 2024

(54) INCREASING COMPUTER SYSTEM EFFICIENCY USING UNIFIED ENCODING

(71) Applicant: Microsoft Technology Licensing, LLC, Redmond, WA (US)

(72) Inventors: Alice Hing-Yee Leung, Sunnyvale, CA (US); Nikita G. Zhiltsov, San Jose, CA (US); Girish Kathalagiri Somashekariah, San Jose, CA (US); Daniel Sairom Krishnan Hewlett, Sunnyvale, CA (US); Yeou Shya Chiou, San Jose, CA (US); Sang Wook Park, San Francisco, CA (US)

(21) Appl. No.: 18/144,082

(22) Filed: May 5, 2023

(51) Int. Cl. G06Q 10/0639; G06N 3/08; G06Q 10/1053

(52) U.S. Cl. CPC G06Q 10/06393; G06N 3/08; G06Q 10/1053

(57) ABSTRACT

Techniques for increasing computer system efficiency using unified encoding are disclosed. In some embodiments, a computer-implemented method comprises: for each skill in a plurality of skills, obtaining a plurality of features for the skill, each feature in the plurality of features comprising a different type of signal indicating a relationship between the skill and a first user; computing a unified embedding of the plurality of features of the plurality of skills for the first user using a neural network and the plurality of features for each skill in the plurality of skills, the computing the unified embedding comprising inputting the plurality of features for each skill in the plurality of skills into the neural network; and using the unified embedding for the first user in an application of an online service, the using the unified embedding comprising causing content to be displayed within a GUI of the application based on the unified embedding.

### TECHNICAL FIELD

The present application relates generally to increasing computer system efficiency using unified encoding.

### BACKGROUND

Online service providers may use attributes of users to provide services to those users. For example, an online service provider may compute recommendations or search results for a user based on an analysis of certain attributes of the user.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating functional components of an online service, in accordance with an example embodiment.

FIG. 2 is a block diagram illustrating functional components of a unified encoding component, in accordance with an example embodiment.

FIG. 3 is a block diagram illustrating an architecture of a neural network of the unified encoding component, in accordance with an example embodiment.

FIG. 4 is a block diagram illustrating another architecture of the neural network of the unified encoding component, in accordance with an example embodiment.

FIG. 5 is a block diagram illustrating yet another architecture of the neural network of the unified encoding component, in accordance with an example embodiment.

FIG. 6 is a flowchart illustrating a method of increasing computer system efficiency using unified encoding, in accordance with an example embodiment.

FIG. 7 illustrates a graphical user interface (GUI) of a job search application, in accordance with an example embodiment.

FIG. 8 illustrates a GUI in which user interface elements that identify profiles of users are displayed, in accordance with an example embodiment.

FIG. 9 illustrates a GUI of an online course application, in accordance with an example embodiment.

FIG. 10 is a block diagram illustrating a software architecture, in accordance with an example embodiment.

FIG. 11 illustrates a diagrammatic representation of a machine in the form of a computer system within which a set of instructions may be executed for causing the machine to perform any one or more of the methodologies discussed herein, in accordance with an example embodiment.

### DETAILED DESCRIPTION

### I. Overview

In the following description, for purposes of explanation, numerous specific details are set forth in order to provide a thorough understanding of example embodiments. It will be evident, however, to one skilled in the art that the present embodiments may be practiced without these specific details.

Current system architectures for processing user attributes fail to compute a single unified embedding to represent a full set of attributes for the user. Instead, a separate embedding is computed for each attribute, and then the multiple separate embeddings are fed to a downstream application for use in that downstream application. As a result of these separate embeddings, the downstream application is burdened with a heavy processing load, which negatively affects the functioning of the underlying computer system of the online service provider.

The above-discussed technical problem of a heavy processing load is addressed by one or more example embodiments disclosed herein, in which a specially-configured computer system is configured to increase computer system efficiency using a single unified embedding for attributes of a user. Attributes of a user are any personal details of the user, such as profile data included in a social networking profile of the user. In some example embodiments, the attributes of the user comprise skills of the user. However, other types of attributes are also within the scope of the present disclosure.

In some example embodiments, the computer system is configured to obtain a plurality of features for each skill in a plurality of skills, where each feature in the plurality of features comprises a different type of signal indicating a relationship between the skill and a first user, and then compute a unified embedding of the plurality of features of the plurality of skills for the first user using a neural network and the plurality of features for each skill in the plurality of skills. The computing of the unified embedding comprises inputting the plurality of features for each skill in the plurality of skills into the neural network. The computer system then uses the unified embedding for the first user in an application of an online service.

By computing a single unified embedding for the plurality of skills using the neural network and then using the unified embedding in the application of the online service, the computer system avoids the excessive processing of multiple separate embeddings for the plurality of skills, thereby reducing the processing load on the computer system and increasing the efficiency of the computer system.

Additionally, skills are a unique type of attribute and present a unique challenge in terms of the computation of their embeddings. Online services may have a skills taxonomy that includes tens of thousands of skills. Skill features that may be used in the computation of skills embeddings may be sparse, being obtained from a variety of different sources (e.g., profiles, resumes) and being determined in different ways (e.g., extracted, inferred). The features of the present disclosure employ a unified encoding approach to create a learned representation of a user's skill set.

There are problems with using an embedding approach for skills in which each skill embedding is tied to its own dense layer, as this approach makes it difficult to share skills across different verticals, such as across different applications of an online service. Furthermore, encoding skill features individually with a fully connected layer fails to accurately and completely represent a user's skill set. The features of the present disclosure involve a more complex shared encoder among a group of sparse features, resulting in a more complex encoder that is better able to learn a representation of the skills of a user. As discussed in further detail below, the solution of the present disclosure may include using a shared skills encoder, which allows for the skills features to be shared across the same dense layer. This approach can improve model performance by feeding first-level embeddings to a deeper encoder to allow the neural network to gain a better understanding of a user's skills. Additionally, this approach provides an effective way for downstream models to use all of the skills features. Instead of simply adding new high-dimensional sparse skill features to the neural network, the techniques of the present disclosure involve learning a unified low-dimensional dense skill representation. Furthermore, using different variations of encodings, as disclosed herein, enables the neural network to learn a better understanding of the user's skills, understanding which skills are important to the user and which skills are not important to the user. Thus, using the single unified embedding imparts a deeper understanding of the user's skills, which can be beneficial to provide more relevant suggestions to the user when used in a professional network context (e.g., improvement in providing more relevant job recommendations, more relevant member connections, and more relevant learning course recommendations).

### II. Detailed Example Embodiments

The methods or embodiments disclosed herein may be implemented as a computer system having one or more components implemented in hardware or software. For example, the methods or embodiments disclosed herein may be embodied as instructions stored on a machine-readable medium that, when executed by one or more hardware processors, cause the one or more hardware processors to perform the instructions.

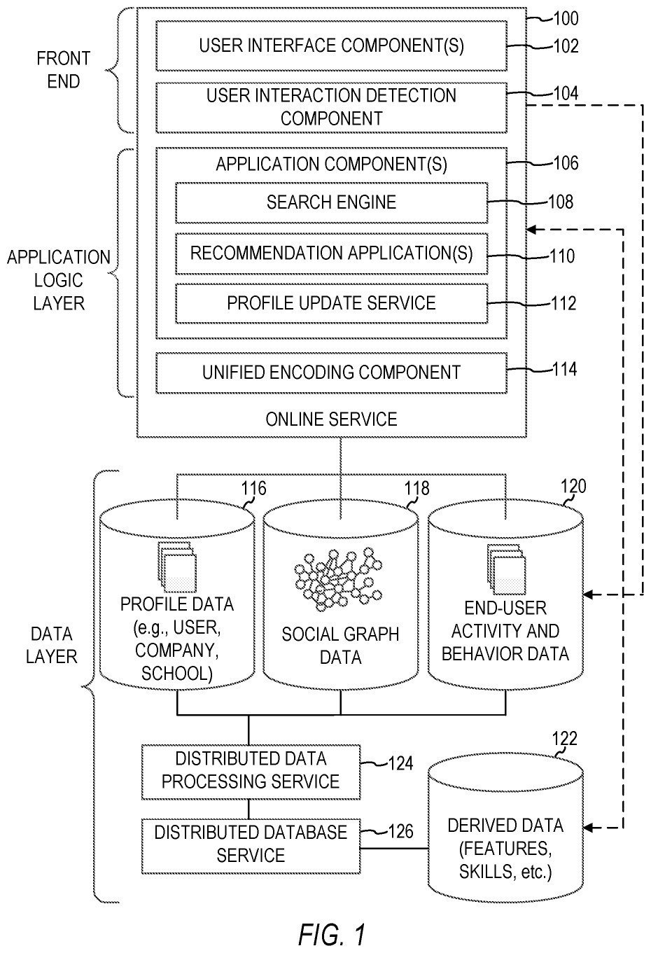

FIG. 1 is a block diagram illustrating functional components of an online service 100, in accordance with an example embodiment. As shown in FIG. 1, a front end may comprise one or more user interface components (e.g., a web server) 102, which receives requests from various client computing devices and communicates appropriate responses to the requesting client devices. For example, the user interface component(s) 102 may receive requests in the form of Hypertext Transfer Protocol (HTTP) requests or other web-based API requests. In addition, a user interaction detection component 104, sometimes referred to as a click tracking service, may be provided to detect various interactions that end-users have with different applications and services, such as those included in the application logic layer of the online service 100. As shown in FIG. 1, upon detecting a particular interaction, the user interaction detection component 104 logs the interaction, including the type of interaction and any metadata relating to the interaction, in an end-user activity and behavior database 120. Accordingly, data from this database 120 can be further processed to generate data appropriate for training one or more machine-learned models, and in particular, for training models to rank a set of skills for an end-user.

An application logic layer may include one or more application components 106, which, in conjunction with the user interface component(s) 102, generate various user interfaces (e.g., web pages) with data retrieved from various data sources in a data layer. Consistent with some embodiments, individual application components 106 implement the functionality associated with various applications and/or services provided by the online service 100. For instance, as illustrated in FIG. 1, the application logic layer includes a variety of applications and services to include a search engine 108, one or more recommendation applications 110 (e.g., a job recommendation application, an online course recommendation application), and a profile update service 112. The various applications and services illustrated as part of the application logic layer are provided as examples and are not meant to be an exhaustive listing of all applications and services that may be integrated with and provided as part of the online service 100. For example, although not shown in FIG. 1, the online service 100 may also include a job hosting service via which end-users submit job postings that can be searched by end-users, and/or recommended to other end-users by the recommendation application(s) 110. As end-user's interact with the various user interfaces and content items presented by these applications and services, the user interaction detection component 104 detects and tracks the end-user interactions, logging relevant information for subsequent use.

As shown in FIG. 1, the data layer may include several databases, such as a profile database 116 for storing profile data, including both end-user profile data and profile data for various organizations (e.g., companies, schools, etc.). Consistent with some embodiments, when a person initially registers to become an end-user of the online service 100, the person will be prompted by the profile update service 112 to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 116. Similarly, when a representative of an organization initially registers the organization with the online service 100, the representative may be prompted to provide certain information about the organization. This information may be stored, for example, in the profile database 116, or another database (not shown).

Once registered, an end-user may invite other end-users, or be invited by other end-users, to connect via the online service 100. A “connection” may constitute a bilateral agreement by the end-users, such that both end-users acknowledge the establishment of the connection. Similarly, with some embodiments, an end-user may elect to “follow” another end-user. In contrast to establishing a connection, the concept of “following” another end-user typically is a unilateral operation and, at least with some embodiments, does not require acknowledgement or approval by the end-user that is being followed. When one end-user follows another, the end-user may receive status updates relating to the other end-user, or other content items published or shared by the other end-user user who is being followed. Similarly, when an end-user follows an organization, the end-user becomes eligible to receive status updates relating to the organization as well as content items published by, or on behalf of, the organization. For instance, content items published on behalf of an organization that an end-user is following will appear in the end-user's personalized feed, sometimes referred to as a content feed or news feed. In any case, the various associations and relationships that the end-users establish with other end-users, or with other entities (e.g., companies, schools, organization) and objects (e.g., metadata hashtags (“#topic”) used to tag content items), are stored and maintained within a social graph in a social graph database 118.

As end-users interact with the various content items that are presented via the applications and services of the online service 100, the end-users' interactions and behaviors (e.g., content viewed, links or buttons selected, messages responded to, job postings viewed, etc.) are tracked by the user interaction detection component 104, and information concerning the end-users' activities and behaviors may be logged or stored, for example, as indicated in FIG. 1 by the end-user activity and behavior database 120.

Consistent with some embodiments, data stored in the various databases of the data layer may be accessed by one or more software agents or applications executing as part of a distributed data processing service 124, which may process the data to generate derived data. The distributed data processing service 124 may be implemented using Apache Hadoop® or some other software framework for the processing of extremely large data sets. Accordingly, an end-user's profile data and any other data from the data layer may be processed (e.g., in the background or offline) by the distributed data processing service 124 to generate various derived profile data. As an example, if an end-user has provided information about various job titles that the end-user has held with the same organization or different organizations, and for how long, this profile information can be used to infer or derive an end-user profile attribute indicating the end-user's overall seniority level or seniority level within a particular organization. This derived data may be stored as part of the end-user's profile or may be written to another database.

In addition to generating derived attributes for end-users' profiles, one or more software agents or applications executing as part of the distributed data processing service 124 may ingest and process data from the data layer for the purpose of generating training data for use in training various machine-learned models, and for use in generating features for use as input to the trained models. For instance, profile data, social graph data, and end-user activity and behavior data, as stored in the databases of the data layer, may be ingested by the distributed data processing service 124 and processed to generate data properly formatted for use as training data for training machine-learned models for constructing a taxonomy graph of entities. Once the derived data and features are generated, they are stored in a database 122, where such data can easily be accessed via calls to a distributed database service 124.

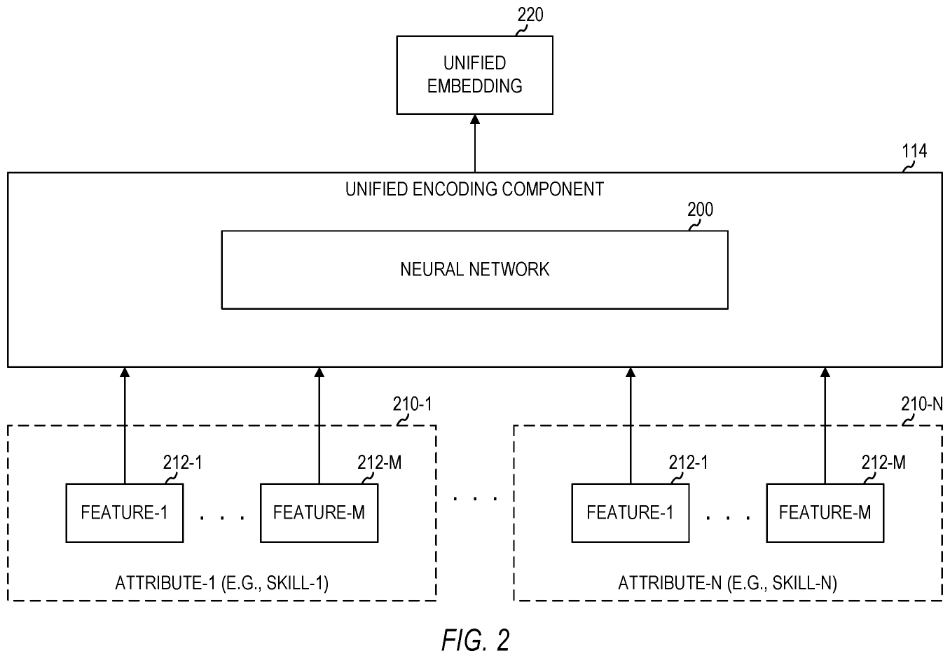

In some example embodiments, the application logic layer of the online service 100 also comprises a unified encoding component 114. FIG. 2 is a block diagram illustrating functional components of the unified encoding component 114, in accordance with an example embodiment. In some example embodiments, the unified encoding component 114 comprises a neural network 200 that is configured to compute a unified embedding 220 for a plurality of attributes 210 of a first user (e.g., ATTRIBUTE-1 210-1 to ATTRIBUTE-N 210-N, where N is an integer greater than 1). The plurality of attributes 210 may comprise a plurality of skills (e.g., SKILL-1 to SKILL-N). However, other types of attributes are also within the scope of the present disclosure.

In some example embodiments, the unified encoding component 114 is configured to obtain a plurality of features 212 for the skill for each skill in a plurality of skills (e.g., FEATURE-1 212-1 to FEATURE-M 212-M, where M is an integer greater than 1). Each feature in the plurality of features comprises a different type of signal indicating a relationship between the attribute 210 and a first user. Furthermore, the plurality of features 212 may be obtained from multiple sources. For example, one feature 212 in the plurality of features 212 may be obtained from a profile of the first user, while another feature in the plurality of features may be obtained from a resume of the first user.

In some example embodiments, the plurality of attributes 210 comprises a plurality of skills, and the plurality of features 212 for one of the plurality of skills comprises any combination of one or more features 212 selected from a group of features 212. One feature 212 in the group of features 212 may comprise an indication that a skill is included in a profile of the first user. For example, the unified encoding component 114 may extract all of the skills listed in a dedicated skills section of the profile of the first user and use the indication of the inclusion of those extracted skills in the profile of the first user as features 212.

Another feature 212 in the group of features 212 may comprise an indication that a skill is not included in the profile of the first user, but that the skill is determined based on the profile of the first user. For example, the unified encoding component 114 may infer one or more skills based on profile data (e.g., title, summary, employment history, job description, job industry) listed in the profile of the first user or on skills listed in the profiles of other users with which the first user is connected, and then use that inference as an indication that the skill is not included in the profile of the first user, but is determined based on the profile of the first user.

Yet another feature 212 in the group of features 212 may comprise an indication that a skill is included in a resume of the first user. For example, the unified encoding component 114 may access the resume of the first user stored in a database of the online service 100 and scan the text of the resume to extract skills included in the text of the resume, such as by using natural language techniques.

Yet another feature 212 in the group of features 212 may comprise an indication of whether an assessment for the skill has been computed for the first user via the online service 100. For example, the first user may answer a set of questions related to a skill via the online service 100, and the online service 100 may then compute an assessment (e.g., a score) for the first user with respect to the skill based on the answers submitted by the first user. The unified encoding component 114 may determine whether the first user participated in this assessment process for use as the indication of whether an assessment for the skill has been computed for the first user.

Other features 212 in the group of features 212 may comprise an indication that the first user has selected to follow the skill via an online learning application of the online service 100, a value indicating a measure of relevance of the skill to a career of the first user, and a value indicating a measure of proficiency of the first user in the skill. Other configurations of the plurality of features 212 for the skill are also within the scope of the present disclosure.

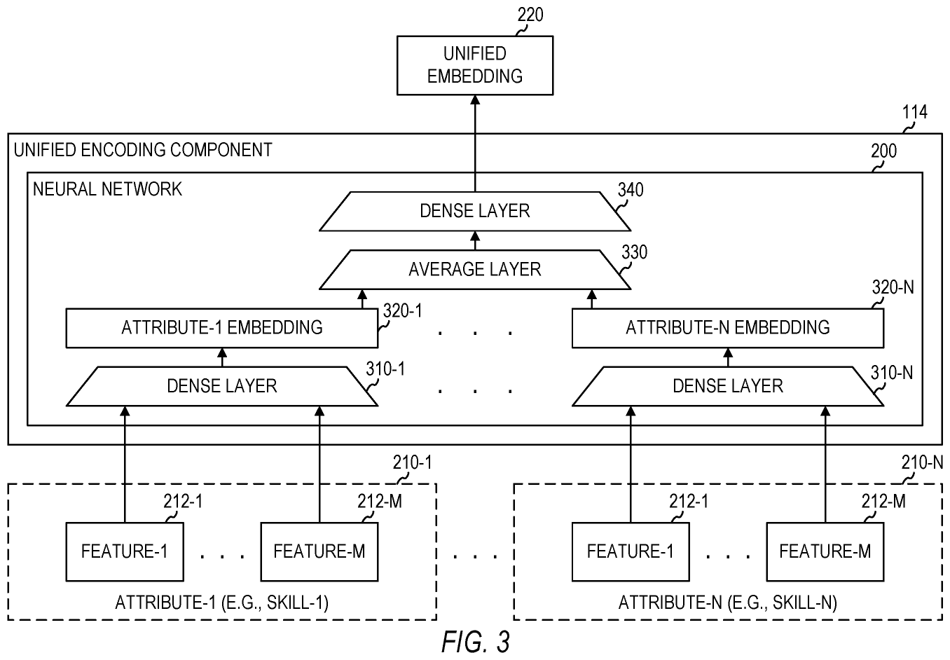

FIG. 3 is a block diagram illustrating an architecture of the neural network 200 of the unified encoding component 114, in accordance with an example embodiment. In the example shown in FIG. 3, the neural network 200 comprises a corresponding dense layer 310 for each attribute 210 in the plurality of attributes 210, an average layer 330, and a dense layer 340. For each attribute 210 in the plurality of attributes 210, the unified encoding component 114 inputs the plurality of features 212 for the attribute 210 into the dense layer 310 of the neural network 200. Each corresponding dense layer 310 is configured to compute a corresponding attribute embedding 320 for the attribute 210. The neural network 200 inputs the attribute embeddings 320 for the plurality of attributes 210 into the average layer 330 of the neural network 200. The average layer 330 is configured to compute an average of the attribute embeddings 320. The average of the attribute embeddings 320 may comprise a weighted average of the attribute embeddings 320. For example, instead of simply averaging the plurality of features 212 and treating each feature 212 equally, the average layer 330 may use a learned weighted average to learn how each feature 212 should be weighted, since some features 212 may provide a better signal to the user's attributes 210 and those may be weighted more heavily. The neural network 200 then inputs the average of the attribute embeddings 320 into the dense layer 340 of the neural network 200. The dense layer 340 is configured to compute the unified embedding 220. The dense layer 340 helps change the dimensionality of the output from the preceding layer so that the neural network model can easily define the relationship between the values of the data in which the neural network model is working. The neural network 200 shown in FIG. 3 comprises a deep averaging network (DAN) architecture. By employing this DAN architecture, the neural network 200 provides a more complex encoder than a simple dense layer and learns a better representation of the user's skills.

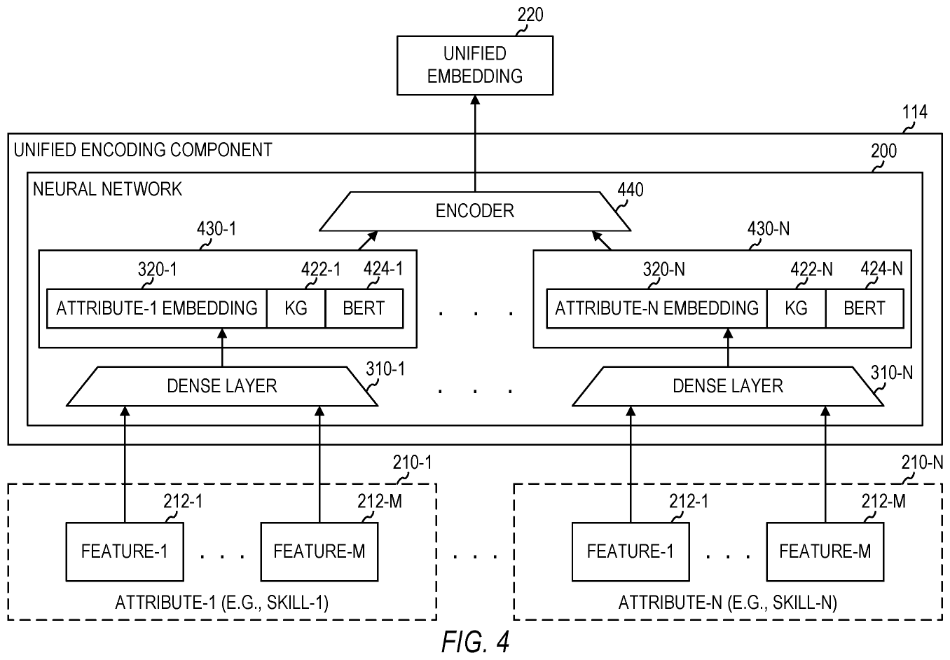

FIG. 4 is a block diagram illustrating another architecture of the neural network 200 of the unified encoding component 114, in accordance with an example embodiment. In the example shown in FIG. 4, the neural network 200, for each attribute 210 in the plurality of attributes 210, inputs the plurality of features 212 for the attribute 210 into a corresponding dense layer 310 of the neural network 200. The corresponding dense layer 310 is configured to compute a corresponding attribute embedding 320 for the attribute 210. Next, the neural network 200, for each attribute 210 in the plurality of attributes 210, computes a concatenation 430 of the attribute embedding 320 for the attribute, a knowledge graph embedding 422 for the attribute 210, and an encoding 424 of a text string of the attribute 210. The encoding 424 may be computed by inputting the text string of the attribute 210 into a Bidirectional Encoder Representations from Transformers (BERT) model. The neural network 200 then, for each attribute 210 in the plurality of attributes 210, inputs the corresponding concatenation 430 for the attribute 210 into an encoder 440 of the neural network 200. The encoder 440 is configured to compute the unified embedding 220. In some example embodiments, the encoder 440 computes an average or a learned weighted average of the concatenations 430 that are input into the encoder 440.

The knowledge graph embeddings 422 are low-dimensional representations of their corresponding attributes 210 and relations in a knowledge graph, such as a knowledge graph of skills stored by the online service 100. The knowledge graph embeddings 422 provide a generalizable context about the overall knowledge graph that can be used to infer relations. By using these knowledge graph embeddings 422 to compute the unified embedding 220, the neural network 200 incorporates this generalizable context into the computation, which improves the ability of the neural network 200 to learn a better representation of the user's attributes. Furthermore, by using the concatenations 430 of the attribute embeddings 320, the knowledge graph embeddings 422, and the encodings 424 of the text strings of the attributes 210, the neural network 200 computes the unified embedding 220 based on a variety of different representations of each attribute 210, thereby improving the ability of the neural network 200 to learn a representation of the user's attributes even more.

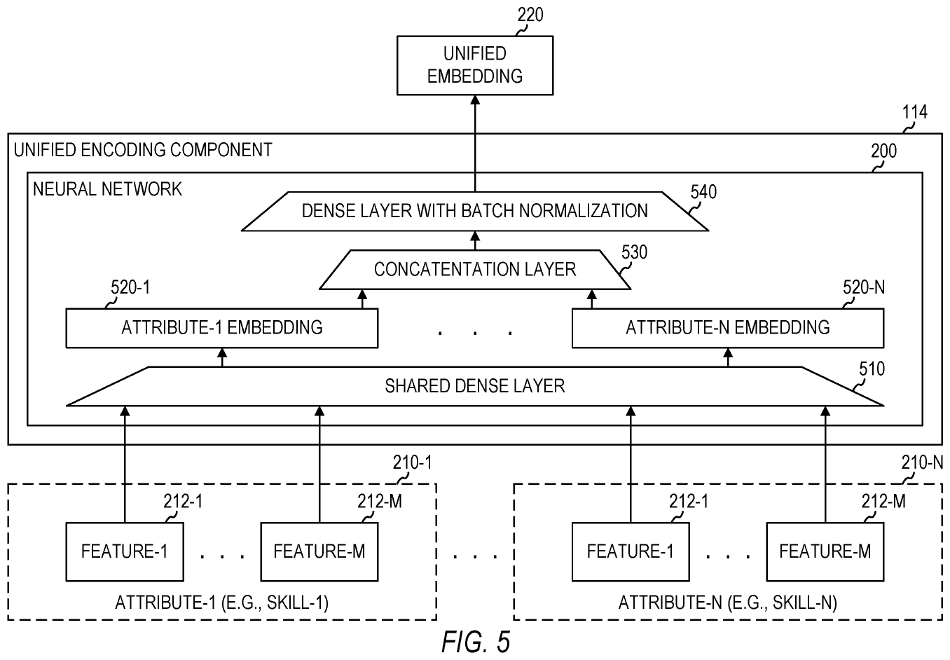

FIG. 5 is a block diagram illustrating yet another architecture of the neural network 200 of the unified encoding component 114, in accordance with an example embodiment. In the example shown in FIG. 5, the neural network 200 inputs the plurality of features 212 for each attribute 210 in the plurality of attributes 210 into a shared dense layer 510 of the neural network 200. The shared dense layer 510 is configured to compute a corresponding attribute embedding 520 for each attribute 210 in the plurality of attributes 210. Next, neural network 200 computes a concatenation of the attribute embeddings 520 of the plurality of attribute 210 using a concatenation layer 530. The neural network 200 then inputs the concatenation of the attribute embeddings 520 into a dense layer 540 having batch normalization. The dense layer 540 is configured to compute the unified embedding 220.

In some example embodiments, the online service 100 is configured to use the unified embedding 220 for the first user in an application of the online service 100. For example, one or more of the application components 106 of the online service 100 may use the unified embedding 220 for the first user. The online service 100 may use the unified embedding 220 to select one or more job postings for display to the first user. The online service 100 may additionally or alternatively use the unified embedding 220 to select one or more potential job candidates for display to a second user. The online service 100 may additionally or alternatively use the unified embedding 220 to select one or more online courses for display to the first user. In addition to the types of applications discussed above, the online service 100 may use the unified embedding 220 in other types of applications as well.

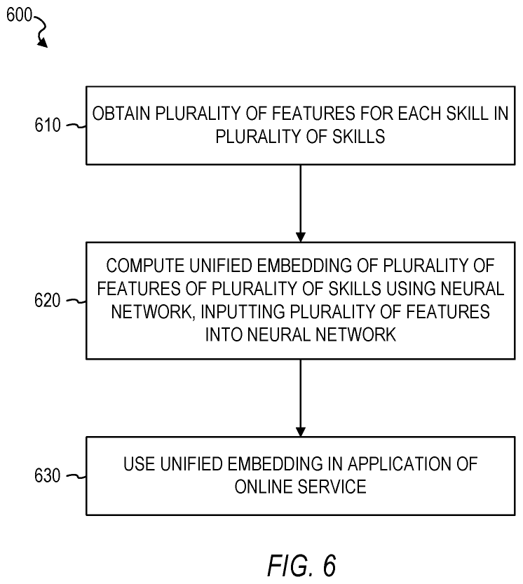

FIG. 6 is a flowchart illustrating a method 600 of increasing computer system efficiency using unified encoding, in accordance with an example embodiment. The method 600 can be performed by processing logic that can comprise hardware (e.g., circuitry, dedicated logic, programmable logic, microcode, etc.), software (e.g., instructions run on a processing device), or a combination thereof. In one implementation, the method 600 is performed by the online service 100 of FIG. 1, or any combination of one or more of its components (e.g., the unified encoding component 114, the application component 106), as described above.

At operation 610, the online service 100 obtains a plurality of features for the skill for each skill in a plurality of skills. Each feature in the plurality of features comprises a different type of signal indicating a relationship between the skill and a first user. Furthermore, the plurality of features may be obtained from multiple sources. For example, one feature in the plurality of features may be obtained from a profile of the first user, while another feature in the plurality of features may be obtained from a resume of the first user. In some example embodiments, the plurality of features for the skill comprises two or more features selected from a group of features consisting of: an indication that the skill is included in a profile of the first user; an indication that the skill is not included in a profile of the first user, but that the skill was determined based on the profile of the first user; an indication that the skill is included in a resume of the first user; an indication of whether an assessment for the skill has been computed for the first user via the online service; an indication that the first user has selected to follow the skill via an online learning application of the online service; a value indicating a measure of relevance of the skill to a career of the first user; and a value indicating a measure of proficiency of the first user in the skill. Other configurations of the plurality of features for the skill are also within the scope of the present disclosure.

At operation 620, the online service 100 computes a unified embedding of the plurality of features of the plurality of skills for the first user using a neural network and the plurality of features for each skill in the plurality of skills. The computing of the unified embedding comprises inputting the plurality of features for each skill in the plurality of skills into the neural network.

In some example embodiments, the computing of the unified embedding further comprises, for each skill in the plurality of skills, inputting the plurality of features for the skill into a corresponding dense layer of the neural network, where the corresponding dense layer is configured to compute a corresponding skill embedding for the skill. Next, the online service 100 may input the skill embeddings for the plurality of skills into an average layer of the neural network, where the average layer is configured to compute an average of the skill embeddings. The average of the skill embeddings may comprise a weighted average of the skill embeddings. The online service 100 may then input the average of the skill embeddings into a dense layer of the neural network, where the dense layer is configured to compute the unified embedding.

In some example embodiments, the computing of the unified embedding further comprises, for each skill in the plurality of skills, inputting the plurality of features for the skill into a corresponding dense layer of the neural network, where the corresponding dense layer is configured to compute a corresponding skill embedding for the skill. Next, the online service 100 may, for each skill in the plurality of skills, compute a concatenation of the skill embedding for the skill, a knowledge graph embedding for the skill, and an encoding of a text string of the skill. The online service 100 may then, for each skill in the plurality of skills, input the corresponding concatenation for the skill into an encoder of the neural network, where the encoder is configured to compute the unified embedding.

In some example embodiments, the computing of the unified embedding further comprises inputting the plurality of features for each skill in the plurality of skills into a shared dense layer of the neural network, where the shared dense layer is configured to compute a corresponding skill embedding for each skill in the plurality of skills. Next, the online service 100 may compute a concatenation of the skill embeddings of the plurality of skills. The online service 100 may then input the concatenation of the skill embeddings into a dense layer having batch normalization, where the dense layer is configured to compute the unified embedding.

At operation 630, the online service 100 uses the unified embedding for the first user in an application of the online service 100. For example, the online service 100 may use the unified embedding for the first user in one of the applications or services implemented by the application component(s) 106 in FIG. 1. The using of the unified embedding may comprise causing content to be presented within a graphical user interface of the application based on the unified embedding.

In some example embodiments, the online service 100 uses the unified embedding for the first user to select one or more job postings for display to the first user. The online service 100 may display the selected job postings as recommendations in response to the first user navigating via a computing device to a particular page of the online service 100 (e.g., a landing page of the online service 100). Additionally or alternatively, the online service 100 may select and display the job postings as search results in response to a search query submitted by the first user. In some example embodiments, the online service 100 uses the unified embedding by computing a corresponding relevance score for each job posting in a plurality of job postings based on a comparison of an embedding of the job posting with the unified embedding, selecting one or more job postings from the plurality of job postings based on the corresponding relevance scores for the one or more job postings, and displaying the selected one or more job postings on a computing device of the first user.

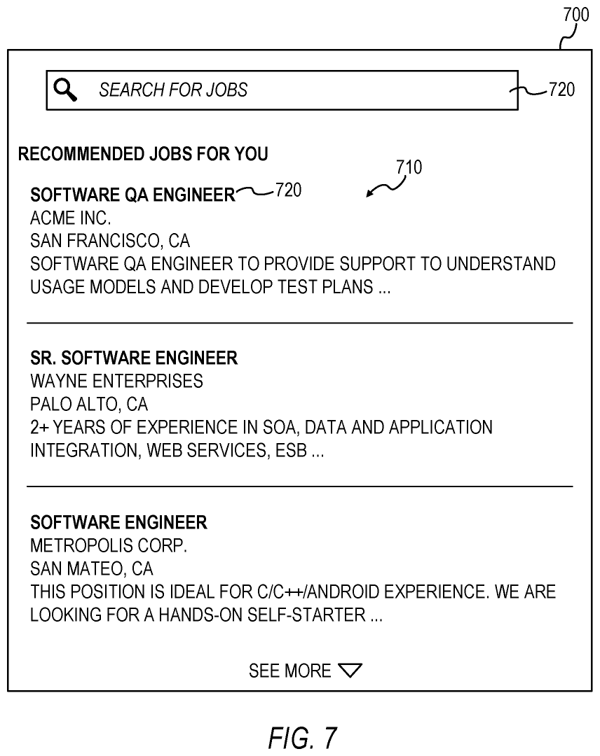

FIG. 7 illustrates a GUI 700 of a job search application, in accordance with an example embodiment. In some example embodiments, the recommendation application 110 displays a corresponding selectable user interface element 720 in association with an indication 710 of the online job postings on a computing device of the first user. The recommendation application 110 may determine which online job postings to recommend to the first user based on a relevance scoring algorithm that calculates a relevance score for each online job posting indicating a level of relevance of the online job posting to the first user. The relevance scoring algorithm may incorporate the use of the unified embedding computed for the first user using unified embedding component 114. The corresponding selectable user interface element 720 may be configured to, in response to its selection, trigger a display of the online job posting on the computing device of the first user or initiate an online application process for the online job posting on the computing device of the first user. The GUI 700 may also include a search field 720 configured to receive a search query from the first user. In response to the search query, the search engine 108 may generate search results for the search query, such as by using the relevance scoring algorithm discussed above.

In some example embodiments, the online service 100 uses the unified embedding for the first user to select one or more potential job candidates for display to a second user. The online service 100 may select and display the potential job candidates as search results in response to a search query submitted by the second user. In some example embodiments, the online service 100 uses the unified embedding by receiving a search query submitted by a second user via a computing device of the second user, computing a relevance score for the first user based on a comparison of the search query and the unified embedding, selecting a profile of the first user based on the relevance score for the first user, and displaying, on the computing device of the second user, a user interface element that identifies the profile of the first user based on the selecting the profile of the first user.

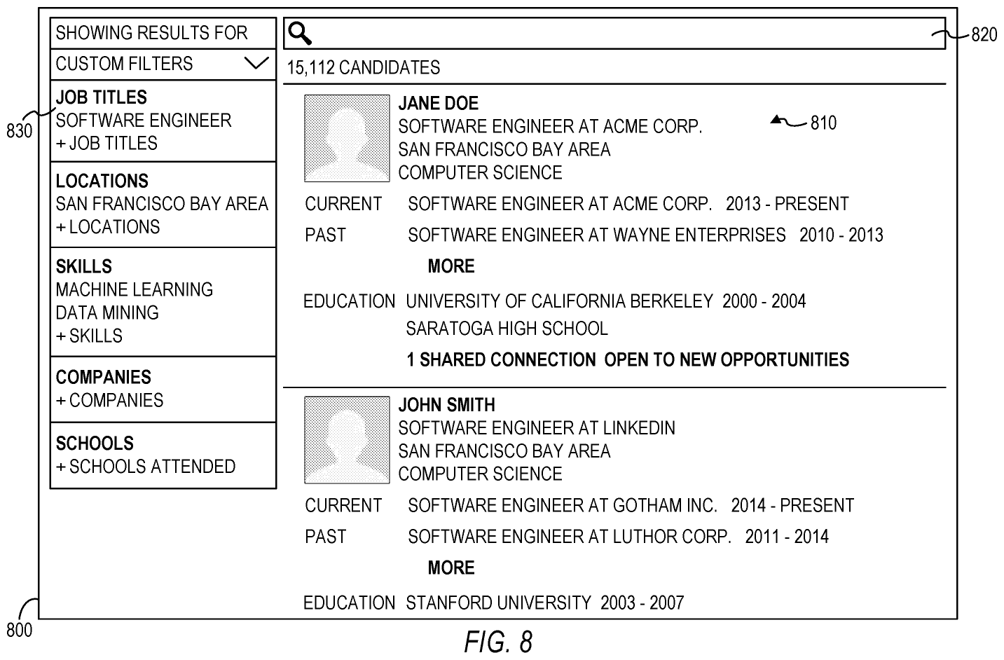

FIG. 8 illustrates a GUI 800 in which user interface elements that identify profiles of users as potential job candidates are displayed, in accordance with an example embodiment. In some example embodiments, the search engine 108 is configured to select profiles of users that are potential job candidates based at least in part on a search query submitted by a user who is searching (referred to as a “searching user”) for potential job candidates, and to cause the selected profiles of the users to be displayed on a search results page of the GUI 800 to the searching user. In the GUI 800, the searching user (e.g., a recruiter) may submit one or more terms of a search query using one or more user interface elements. For example, the searching user may submit the term(s) by either entering text into a search field 820 or by using a custom search filters panel 830 via which the searching user may select and enter the terms based on the corresponding category of the terms (e.g., job titles, locations, skills, companies, schools). In response to the search query submitted by the searching user, the search engine 108 may cause user interface elements 810 that identify the selected profiles to be displayed on the search results page. The search engine 108 may use computed unified embeddings of potential job candidates in selecting which user profiles to present as search results. For example, if the searching user includes the skill “Machine Learning” in a search query, the search engine 108 may compute a corresponding similarity measurement (e.g., a cosine similarity) for each job candidate profile based on a comparison between the corresponding unified embedding of the job candidate profile and an embedding of the skill “Machine Learning.”

In some example embodiments, the online service 100 uses the unified embedding for the first user to select one or more online courses for display to the first user. The online service 100 may display the selected online courses as recommendations in response to the first user navigating via a computing device to a particular page of the online service 100 (e.g., a landing page of the online service 100). Additionally or alternatively, the online service 100 may select and display the online courses as search results in response to a search query submitted by the first user. In some example embodiments, the online service 100 may use the unified embedding by computing a corresponding relevance score for each online course in a plurality of online courses based on a comparison of an embedding of the online course with the unified embedding, selecting one or more online courses from the plurality of online courses based on the corresponding relevance scores for the one or more online courses, and displaying the selected one or more online courses on a computing device of the first user.

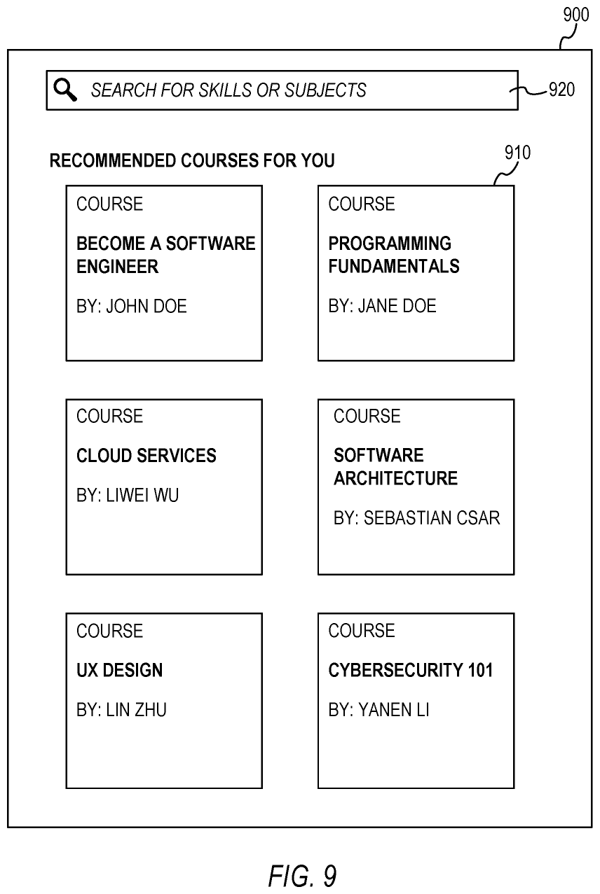

FIG. 9 illustrates a GUI 900 of an online course application, in accordance with an example embodiment. The recommendation application 110 may display a corresponding selectable user interface element 910 in association with an indication of an online course on a computing device of the first user. The recommendation application 110 may determine which online courses to recommend to the first user based on a relevance scoring algorithm that calculates a relevance score for each online course indicating a level of relevance of the online course to the first user. The relevance scoring algorithm may incorporate the use of the computed unified embedding of the first user. The corresponding selectable user interface element 910 may be configured to, in response to its selection, trigger an online process for playing the online course on the computing device of the first user. The GUI 900 may also include a search field 920 configured to receive a search query from the first user. In response to the search query, the search engine 108 may generate search results for the search query, such as by using the relevance scoring algorithm discussed above.

In addition to the types of applications discussed above, the online service 100 may, at operation 630, use the unified embedding in other types of applications as well.

It is contemplated that any of the other features described within the present disclosure can be incorporated into the method 600.

Certain embodiments are described herein as including logic or a number of components or mechanisms. Components may constitute either software components (e.g., code embodied (1) on a non-transitory machine-readable medium or (2) in a transmission signal) or hardware-implemented components. A hardware-implemented component is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented component that operates to perform certain operations as described herein.

In various embodiments, a hardware-implemented component may be implemented mechanically or electronically. For example, a hardware-implemented component may comprise dedicated circuitry or logic that is permanently configured (e.g., as a special-purpose processor, such as a field programmable gate array (FPGA) or an application-specific integrated circuit (ASIC)) to perform certain operations. A hardware-implemented component may also comprise programmable logic or circuitry (e.g., as encompassed within a programmable processor) that is temporarily configured by software to perform certain operations. It will be appreciated that the decision to implement a hardware-implemented component mechanically, in dedicated and permanently configured circuitry, or in temporarily configured circuitry (e.g., configured by software) may be driven by cost and time considerations.

Accordingly, the term “hardware-implemented component” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented components are temporarily configured (e.g., programmed), each of the hardware-implemented components need not be configured or instantiated at any one instance in time. For example, where the hardware-implemented components comprise a processor configured using software, the processor may be configured as respective different hardware-implemented components at different times. Software may accordingly configure a processor, for example, to constitute a particular hardware-implemented component at one instance of time and to constitute a different hardware-implemented component at a different instance of time.

Hardware-implemented components can provide information to, and receive information from, other hardware-implemented components. Accordingly, the described hardware-implemented components may be regarded as being communicatively coupled. Where multiple of such hardware-implemented components exist contemporaneously, communications may be achieved through signal transmission (e.g., over appropriate circuits and buses) that connect the hardware-implemented components. In embodiments in which multiple hardware-implemented components are configured or instantiated at different times, communications between such hardware-implemented components may be achieved, for example, through the storage and retrieval of information in memory structures to which the multiple hardware-implemented components have access. For example, one hardware-implemented component may perform an operation, and store the output of that operation in a memory device to which it is communicatively coupled. A further hardware-implemented component may then, at a later time, access the memory device to retrieve and process the stored output. Hardware-implemented components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Similarly, the methods described herein may be at least partially processor-implemented. For example, at least some of the operations of a method may be performed by one or more processors or processor-implemented components. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a component, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on target data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

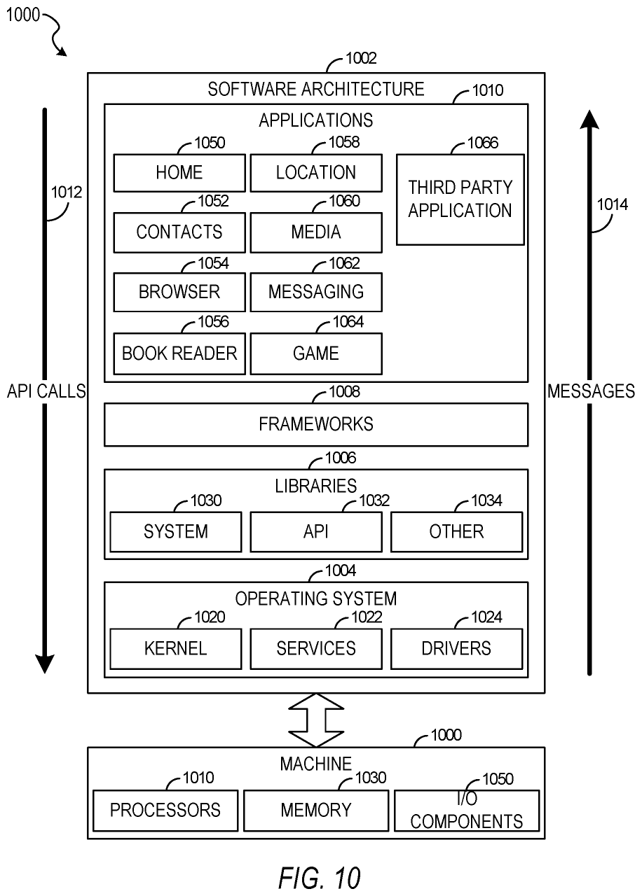

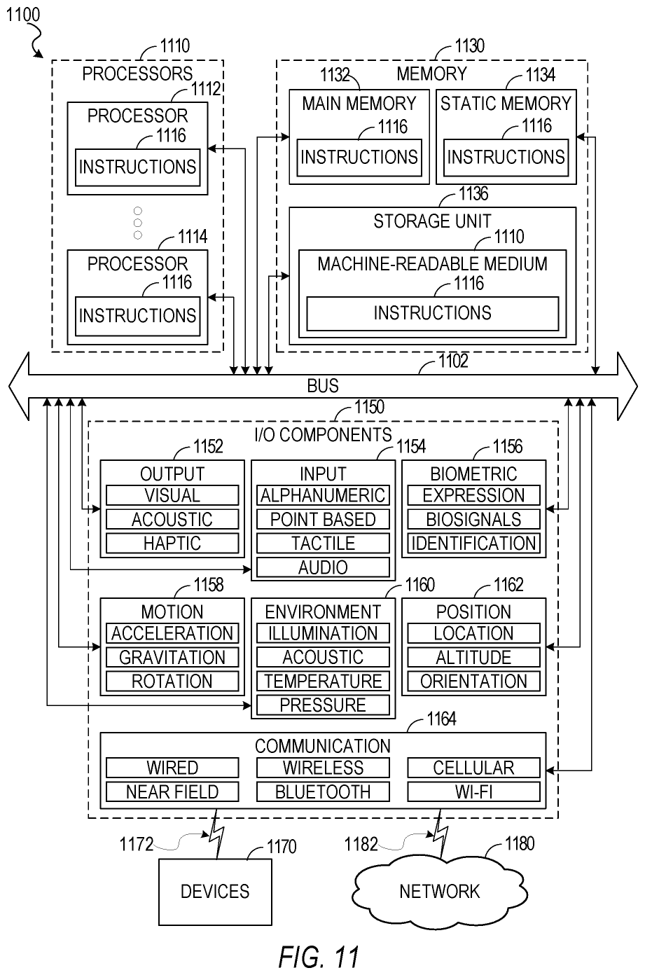

FIG. 10 is a block diagram 1000 illustrating a software architecture 1002, which can be installed on any one or more of the devices described above. FIG. 10 is merely a non-limiting example of a software architecture, and it will be appreciated that many other architectures can be implemented to facilitate the functionality described herein. In various embodiments, the software architecture 1002 is implemented by hardware such as a machine 1100 of FIG. 11 that includes processors 1010, memory 1030, and input/output (I/O) components 1050. In this example architecture, the software architecture 1002 can be conceptualized as a stack of layers where each layer may provide a particular functionality. For example, the software architecture 1002 includes layers such as an operating system 1004, libraries 1006, frameworks 1008, and applications 1010. Operationally, the applications 1010 invoke API calls 1012 through the software stack and receive messages 1014 in response to the API calls 1012, consistent with some embodiments.

In various implementations, the operating system 1004 manages hardware resources and provides common services. The operating system 1004 includes, for example, a kernel 1020, services 1022, and drivers 1024. The kernel 1020 acts as an abstraction layer between the hardware and the other software layers, consistent with some embodiments. For example, the kernel 1020 provides memory management, processor management (e.g., scheduling), component management, networking, and security settings, among other functionality. The services 1022 can provide other common services for the other software layers. The drivers 1024 are responsible for controlling or interfacing with the underlying hardware, according to some embodiments. For instance, the drivers 1024 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 1006 provide a low-level common infrastructure utilized by the applications 1010. The libraries 1006 can include system libraries 1030 (e.g., C standard library) that can provide functions such as memory allocation functions, string manipulation functions, mathematic functions, and the like. In addition, the libraries 1006 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 1006 can also include a wide variety of other libraries 1034 to provide many other APIs to the applications 1010.

The frameworks 1008 provide a high-level common infrastructure that can be utilized by the applications 1010, according to some embodiments. For example, the frameworks 1008 provide various GUI functions, high-level resource management, high-level location services, and so forth. The frameworks 1008 can provide a broad spectrum of other APIs that can be utilized by the applications 1010, some of which may be specific to a particular operating system 1004 or platform.

In an example embodiment, the applications 1010 include a home application 1050, a contacts application 1052, a browser application 1054, a book reader application 1056, a location application 1058, a media application 1060, a messaging application 1062, a game application 1064, and a broad assortment of other applications, such as a third-party application 1066. According to some embodiments, the applications 1010 are programs that execute functions defined in the programs. Various programming languages can be employed to create one or more of the applications 1010, structured in a variety of manners, such as object-oriented programming languages (e.g., Objective-C, Java, or C++) or procedural programming languages (e.g., C or assembly language). In a specific example, the third-party application 1066 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1066 can invoke the API calls 1012 provided by the operating system 1004 to facilitate functionality described herein.

FIG. 11 illustrates a diagrammatic representation of a machine 1100 in the form of a computer system within which a set of instructions may be executed for causing the machine 1100 to perform any one or more of the methodologies discussed herein, according to an example embodiment. Specifically, FIG. 11 shows a diagrammatic representation of the machine 1100 in the example form of a computer system, within which instructions 1116 (e.g., software, a program, an application 1110, an applet, an app, or other executable code) for causing the machine 1100 to perform any one or more of the methodologies discussed herein may be executed. For example, the instructions 1116 may cause the machine 1100 to execute the method 600 of FIG. 6. Additionally, or alternatively, the instructions 1116 may implement FIGS. 1-9, and so forth. The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an example embodiment, the processors 1110 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1112 and a processor 1114 that may execute the instructions 1116. The term “processor” is intended to include multi-core processors 1110 that may comprise two or more independent processors 1112 (sometimes referred to as “cores”) that may execute instructions 1116 contemporaneously. Although FIG. 11 shows multiple processors 1110, the machine 1100 may include a single processor 1112 with a single core, a single processor 1112 with multiple cores (e.g., a multi-core processor), multiple processors 1110 with a single core, multiple processors 1110 with multiple cores, or any combination thereof.

The memory 1130 may include a main memory 1132, a static memory 1134, and a storage unit 1136, all accessible to the processors 1110 such as via the bus 1102. The main memory 1132, the static memory 1134, and the storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 may include a wide variety of components to receive input, provide output, produce output, transmit information, exchange information, capture measurements, and so on. The specific I/O components 1150 that are included in a particular machine 1100 will depend on the type of machine 1100. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion, and the grouping is in no way limiting. In various example embodiments, the I/O components 1150 may include output components 1152 and input components 1154. The output components 1152 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162, among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1162 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

The various memories (i.e., 1130, 1132, 1134, and/or memory of the processor(s) 1110) and/or the storage unit 1136 may store one or more sets of instructions 1116 and data structures (e.g., software) embodying or utilized by any one or more of the methodologies or functions described herein. These instructions (e.g., the instructions 1116), when executed by the processor(s) 1110, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1116 and/or data. The terms shall accordingly be taken to include, but not be limited to, solid-state memories, and optical and magnetic media, including memory internal or external to the processors 1110. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1180 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 1116 may be transmitted or received over the network 1180 using a transmission medium via a network interface device (e.g., a network interface component included in the communication components 1164) and utilizing any one of a number of well-known transfer protocols (e.g., HTTP). Similarly, the instructions 1116 may be transmitted or received using a transmission medium via the coupling 1172 (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1116 for execution by the machine 1100, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method performed by a computer system having a memory and at least one hardware processor, the computer-implemented method comprising:
for each skill in a plurality of skills, obtaining a plurality of features for the skill, each feature in the plurality of features comprising a different type of signal indicating a relationship between the skill and a first user;
computing a unified embedding of the plurality of features of the plurality of skills for the first user using a neural network and the plurality of features for each skill in the plurality of skills, the computing the unified embedding comprising inputting the plurality of features for each skill into the neural network; and
using the unified embedding for the first user in an application of an online service, the using the unified embedding comprising causing content to be presented within a graphical user interface of the application based on the unified embedding.

2. The computer-implemented method of claim 1, wherein the plurality of features for the skill comprises an indication that the skill is included in a profile of the first user, the profile being stored in a database of the online service.

3. The computer-implemented method of claim 1, wherein the plurality of features for the skill comprises an indication that the skill is not included in a profile of the first user and that the skill was determined based on the profile of the first user, the profile being stored in a database of the online service.

4. The computer-implemented method of claim 1, wherein the plurality of features for the skill comprises an indication that the skill is included in a resume of the first user, the resume being stored in a database of the online service.

5. The computer-implemented method of claim 1, wherein the plurality of features for the skill comprises an indication of whether an assessment for the skill has been computed for the first user via the online service.

6. The computer-implemented method of claim 1, wherein the plurality of features for the skill comprises an indication that the first user has selected to follow the skill via an online learning application of the online service.

7. The computer-implemented method of claim 1, wherein the plurality of features for the skill comprises a value indicating a measure of relevance of the skill to a career of the first user.

8. The computer-implemented method of claim 1, wherein the plurality of features for the skill comprises a value indicating a measure of proficiency of the first user in the skill.

9. The computer-implemented method of claim 1, wherein the computing the unified embedding further comprises:
for each skill in the plurality of skills, inputting the plurality of features for the skill into a corresponding dense layer of the neural network, the corresponding dense layer being configured to compute a corresponding skill embedding for the skill;
inputting the skill embeddings for the plurality of skills into an average layer of the neural network, the average layer being configured to compute an average of the skill embeddings; and
inputting the average of the skill embeddings into a dense layer of the neural network, the dense layer being configured to compute the unified embedding.

10. The computer-implemented method of claim 9, wherein the average of the skill embeddings comprises a weighted average of the skill embeddings.

11. The computer-implemented method of claim 1, wherein the computing the unified embedding further comprises:
for each skill in the plurality of skills, inputting the plurality of features for the skill into a corresponding dense layer of the neural network, the corresponding dense layer being configured to compute a corresponding skill embedding for the skill;
for each skill in the plurality of skills, computing a computing a concatenation of the skill embedding for the skill, a knowledge graph embedding for the skill, and an encoding of a text string of the skill; and
for each skill in the plurality of skills, inputting the corresponding concatenation for the skill into an encoder of the neural network, the encoder being configured to compute the unified embedding.

12. The computer-implemented method of claim 1, wherein the computing the unified embedding further comprises:
inputting the plurality of features for each skill in the plurality of skills into a shared dense layer of the neural network, the shared dense layer being configured to compute a corresponding skill embedding for each skill in the plurality of skills;
computing a concatenation of the skill embeddings of the plurality of skills; and
inputting the concatenation of the skill embeddings into a dense layer having batch normalization, the dense layer being configured to compute the unified embedding.

13. The computer-implemented method of claim 1, wherein the using the unified embedding for the user in the application of the online service comprises:
for each job posting in a plurality of job postings, computing a corresponding relevance score based on a comparison of an embedding of the job posting with the unified embedding;
selecting one or more job postings from the plurality of job postings based on the corresponding relevance scores for the one or more job postings; and
displaying the selected one or more job postings on a computing device of the first user.

14. The computer-implemented method of claim 1, wherein the using the unified embedding for the user in the application of the online service comprises:
receiving a search query submitted by a second user via a computing device of the second user;
computing a relevance score for the first user based on a comparison of the search query and the unified embedding;
selecting a profile of the first user based on the relevance score for the first user; and
displaying, on the computing device of the second user, a user interface element that identifies the profile of the first user based on the selecting the profile of the first user.

15. The computer-implemented method of claim 1, wherein the using the unified embedding for the user in the application of the online service comprises:
for each online course in a plurality of online courses, computing a corresponding relevance score based on a comparison of an embedding of the online course with the unified embedding;
selecting one or more online courses from the plurality of online courses based on the corresponding relevance scores for the one or more online courses; and
displaying the selected one or more online courses on a computing device of the first user.

16. A system comprising:
at least one hardware processor; and
a non-transitory machine-readable medium embodying a set of instructions that, when executed by the at least one hardware processor, cause the at least one hardware processor to perform operations, the operations comprising:
for each skill in a plurality of skills, obtaining a plurality of features for the skill, each feature in the plurality of features comprising a different type of signal indicating a relationship between the skill and a first user;
computing a unified embedding of the plurality of features of the plurality of skills for the first user using a neural network and the plurality of features for each skill in the plurality of skills, the computing the unified embedding comprising inputting the plurality of features for each skill in the plurality of skills into the neural network; and
using the unified embedding for the first user in an application of an online service, the using the unified embedding comprising causing content to be presented within a graphical user interface of the application based on the unified embedding.

17. The system of claim 16, wherein the plurality of features for the skill comprises two or more features selected from a group of features consisting of:
an indication that the skill is included in a profile of the first user, the profile being stored in a database of the online service;
an indication that the skill is not included in a profile of the first user and that the skill was determined based on a profile of the first user, the profile being stored in a database of the online service;
an indication that the skill is included in a resume of the first user, the resume being stored in a database of the online service;
an indication of whether an assessment for the skill has been computed for the first user via the online service;
an indication that the first user has selected to follow the skill via an online learning application of the online service;
a value indicating a measure of relevance of the skill to a career of the first user; and
a value indicating a measure of proficiency of the first user in the skill.

18. The system of claim 16, wherein the computing the unified embedding further comprises:
inputting the plurality of features for each skill in the plurality of skills into a shared dense layer of the neural network, the shared dense layer being configured to compute a corresponding skill embedding for each skill in the plurality of skills;
computing a concatenation of the skill embeddings of the plurality of skills; and
inputting the concatenation of the skill embeddings into a dense layer having batch normalization, the dense layer being configured to compute the unified embedding.

19. The system of claim 16, wherein the using the unified embedding for the user in the application of the online service comprises:
for each job posting in a plurality of job postings, computing a corresponding relevance score based on a comparison of an embedding of the job posting with the unified embedding;
selecting one or more job postings from the plurality of job postings based on the corresponding relevance scores for the one or more job postings; and
displaying the selected one or more job postings on a computing device of the first user.

20. A non-transitory machine-readable medium embodying a set of instructions that, when executed by at least one hardware processor, cause the at least one hardware processor to perform operations, the operations comprising:
for each skill in a plurality of skills, obtaining a plurality of features for the skill, each feature in the plurality of features comprising a different type of signal indicating a relationship between the skill and a first user;
computing a unified embedding of the plurality of features of the plurality of skills for the first user using a neural network and the plurality of features for each skill in the plurality of skills, the computing the unified embedding comprising inputting the plurality of features for each skill in the plurality of skills into the neural network; and
using the unified embedding for the first user in an application of an online service, the using the unified embedding comprising causing content to be presented within a graphical user interface of the application based on the unified embedding.
